(19) United States
(12) Patent Application Publication
(10) Pub. No.: US 2015/0273588 A1
(43) Pub. Date: Oct. 1, 2015

(54) APPARATUS FOR ON-LINE DEBURRING WHEEL BLANK

(71) Applicant: CITIC Dicastal CO., LTD., Qinhuangdo (CN)

(72) Inventors: Xue Bowen, Qinhuangdao (CN); Hou Dejian, Qinhuangdao (CN); Guo Jiandong, Qinhuangdao (CN)

(21) Appl. No.: 14/669,023

(22) Filed: Mar. 26, 2015

(30) Foreign Application Priority Data
Mar. 26, 2014 (CN) 201410115790.8

(51) Int. Cl. B23B 5/28; B23B 5/16; B22D 31/00

(52) U.S. Cl. CPC B23B 5/28; B22D 31/00; B23B 5/16; B23B 2215/08; B23B 2220/08; B23B 2222/04

(57) ABSTRACT

The present invention discloses an apparatus for on-line deburring wheel blank, which comprises a body frame, cylinders, rails, slidable tables, electric motors and cutting systems, etc. When the wheel blank on a conveyor belt is transported to the central location between left clamping blocks and right clamping blocks, the blank is stopped by sensor(s) and lifted by a lifting cylinder via a bracket. Through a gear and two racks, a clamping cylinder drives the left slidable table and the right slidable table to synchronously clamp the wheel blank. A first electric motor drives the clamped wheel blank to rotate in counterclockwise direction. A first feeding cylinder feeds the right lathe tool to make it contact the wheel rim. The function of removing burrs on the wheel rim, which are caused upon closing molds, is realized by the relative movement between the wheel and the lathe tool.

### CROSS-REFERENCE TO RELATED APPLICATION

Priority is claimed to Chinese Application No. 201410115790.8, filed Mar. 26, 2014, and the entire contents thereof are hereby incorporated by reference.

### TECHNICAL FIELD

The present invention relates to a surface treatment apparatus, in particular to a deburring apparatus.

### BACKGROUND

During casting process of aluminum alloy wheel, due to long-term use of molds, molten aluminum may overflow from four sides of the molds to form burrs. If the burrs are not removed in time, it will severely influence positioning of the subsequent X ray detection equipment, sprue-removing equipment and machining equipment. Although the device described in patent CN102554199B is able to realize automated on-line deburring of wheel blank, it is often encountered during casting that the actions of four hydraulic cylinders at four sides of the molds are out of synchronization, causing misalignment of the molds at the wheel rims. This will lead to halting alarm and downtime of the equipments, lowering production efficiency. The deburring apparatus described by the present invention completely solves the above mentioned problems.

### SUMMARY

It is an object of the present invention to provide an apparatus for on-line deburring wheel blank, which could adapt to the wheel planks produced when occurring misalignments of molds.

To achieve the above purpose, the technical solution of the present invention comprises: a body frame, a platform, a first rail, a left slidable table, a chain, a clamping cylinder, a first electric motor, two left bearing blocks, two left shafts, two left clamping blocks, two right clamping blocks, two right shafts, two right bearing blocks, a right lathe tool, a right slidable seat, a first feeding cylinder, a second rail, a first supporting frame, a right slidable table, two racks, a gear, a second electric motor, a supporting plate, a lifting cylinder, a conveyor belt, a bracket, a second supporting frame, a third rail, a left slidable seat, a second feeding cylinder and a left lathe tool. The left slidable table and the right slidable table are mounted on the platform through the first rail. The output rod of the clamping cylinder, which is fixed to the left side of the body frame, is connected with the left slidable table. The two left shafts, each of which is mounted with one left clamping block at their upper ends respectively, are fixed into the two left bearing blocks via bearings. The two left bearing blocks and the first electric motor are both mounted on the left slidable table. The first electric motor drives the two left shafts and the two clamping blocks to rotate via the chain. The two right shafts, each of which is mounted with one right clamping block at their upper ends, are fixed via bearings into the right bearing blocks on the right slidable table.

The first supporting frame is fixed on the right slidable table. The right slidable seat, which is mounted with the right lathe tool, is connected with the first supporting frame through the second rail. The output end of the first feeding cylinder, which is fixed to the side of the right slidable table, is connected with the right slidable seat so as to realize the feeding movement of the right lathe tool. The above-mentioned components constitute a right cutting system of the apparatus.

The second supporting frame is fixed on the left slidable table. The left slidable seat, which is mounted with the left lathe tool, is connected with the second supporting frame through the third rail. The output end of the second feeding cylinder, which is fixed to the side of the left slidable table, is connected with the left slidable seat so as to realize the feeding movement of the left lathe tool. The above-mentioned components constitute a left cutting system of the apparatus.

The two racks, each of which is mounted at lower parts of the left slidable table and the right slidable table respectively, mesh with the gear fixed in the middle of the platform. As such, the clamping cylinder could drive the left slidable table to make the left slidable table and the right slidable table synchronously clamp the wheel blank.

The lifting cylinder, the output end of which is fixed with the bracket, is mounted to the top end of the supporting plate on the platform. The second electric motor, which is mounted below the platform, drives the conveyor belt to rotate so as to realize on-line processing.

The noses of the left lathe tool and the right lathe tool are both positionally biased from the axis C of the wheel.

In practical use, when the wheel blank on the conveyor belt is transported to the central location between the left clamping blocks and the right clamping blocks, the blank is stopped by sensor(s) and lifted by the lifting cylinder via the bracket. Through the gear and the racks, the clamping cylinder drives the left slidable table to make the left slidable table and the right slidable table synchronously clamp the wheel blank. The first electric motor drives the clamped wheel blank to rotate in counterclockwise direction. The first feeding cylinder feeds the right lathe tool to make it contact the wheel rim. The function of removing burrs on the wheel rim, which are caused upon closing molds, is realized by the relative movement between the wheel and the lathe tool. When the wheel blank is produced with misalignment of molds occurring, the right lathe tool will block the wheel and prevent it from rotating, which will make the first electric motor overloaded. Under this circumstance, the right lathe tool could be moved back to its original location. Then the first electric motor dives the clamped wheel blank to rotate in clockwise direction, and the second feeding cylinder feeds the left lathe tool. Upon contacting the wheel blank, the left lathe tool could continue the deburring operation.

In use, the present invention could adapt to wheel planks of any states in respect of removing burrs on the wheel rim, which are caused upon closing molds. Accordingly, it effectively addresses the problem of equipment halting during processing, which stems from misalignment of molds, and therefore possesses such advantages as increased automation, advanced processing as well as secure and stable performances, etc.

### BRIEF DESCRIPTION OF THE DRAWINGS

FIG. 1 is a front view of an apparatus for on-line deburring wheel blank of the present invention.

FIG. 2 is a top view of the apparatus for on-line deburring wheel blank of the present invention.

FIG. 3 is a cross-sectional view, taken along the section line A-A, of the apparatus for on-line deburring wheel blank of the present invention.

FIG. 4 is a cross-sectional view, taken along the section line B-B, of the apparatus for on-line deburring wheel blank of the present invention.

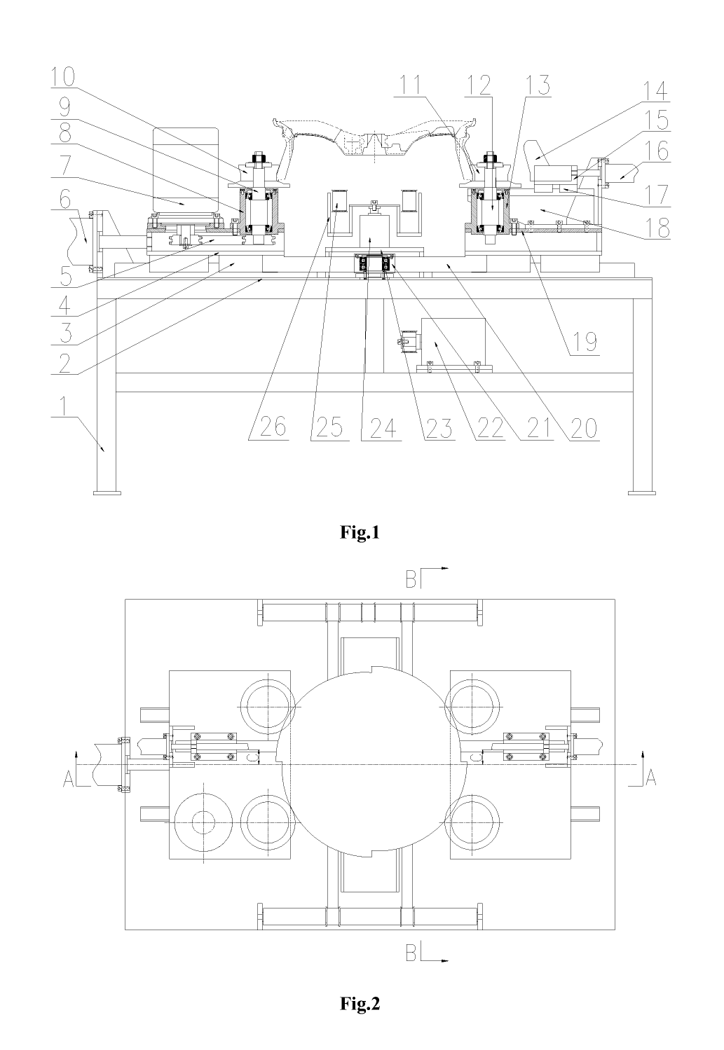

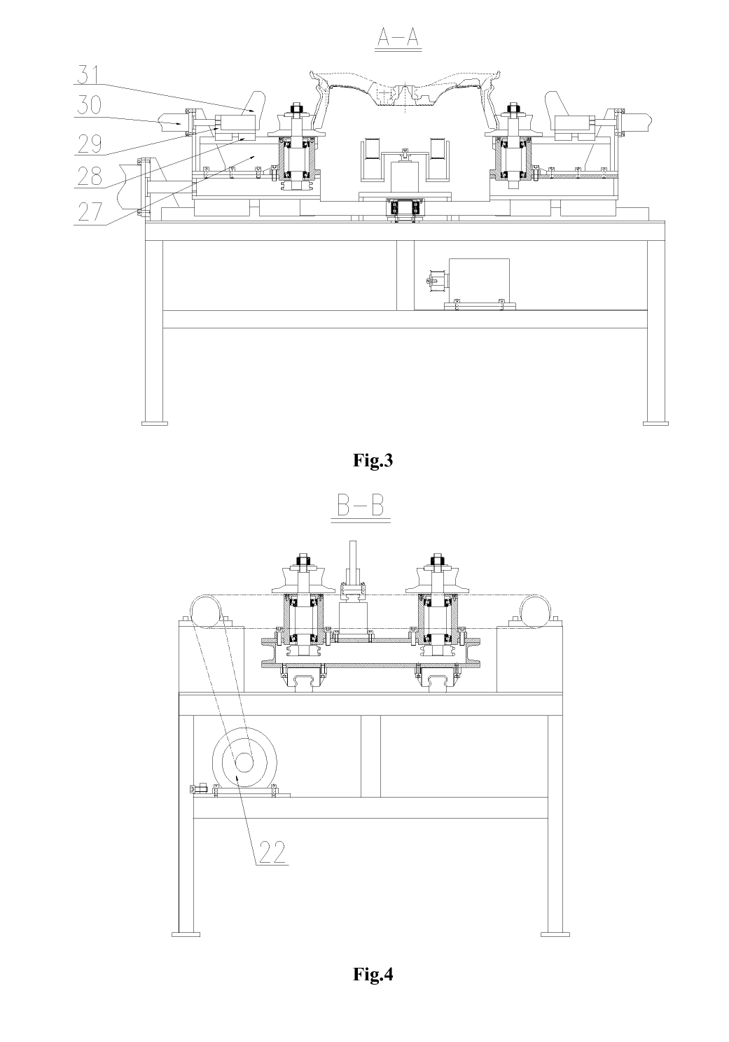

In the drawings, the corresponding relationships between the components and the reference numbers are as follows: 1—body frame, 2—platform, 3—first rail, 4—left slidable table, 5—chain, 6—clamping cylinder, 7—first electric motor, 8—left bearing block, 9—left shaft, 10—left clamping block, 11—right clamping block, 12—right shaft, 13—right bearing block, 14—right lathe tool, 15—right slidable seat, 16—first feeding cylinder, 17—second rail, 18—first supporting frame, 19—right slidable table, 20—rack, 21—gear, 22—second electric motor, 23—supporting plate, 24—lifting cylinder, 25—conveyor belt, 26—bracket, 27—second supporting frame, 28—third rail, 29—left slidable seat, 30—second feeding cylinder, 31—left lathe tool.

### DETAILED EMBODIMENTS

The details and operations of the specific apparatus proposed by the present invention will now described in conjunction with the drawings.

The apparatus comprises: a body frame 1, a platform 2, a first rail 3, a left slidable table 4, a chain 5, a clamping cylinder 6, a first electric motor 7, two left bearing blocks 8, two left shafts 9, two left clamping blocks 10, two right clamping blocks 11, two right shafts 12, two right bearing blocks 13, a right lathe tool 14, a right slidable seat 15, a first feeding cylinder 16, a second rail 17, a first supporting frame 18, a right slidable table 19, two racks 20, a gear 21, a second electric motor 22, a supporting plate 23, a lifting cylinder 24, a conveyor belt 25, a bracket 26, a second supporting frame 27, a third rail 28, a left slidable seat 29, a second feeding cylinder 30 and a left lathe tool 31. The left slidable table 4 and the right slidable table 19 are mounted on the platform 2 through the first rail 3. The output rod of the clamping cylinder 6, which is fixed to the left side of the body frame 1, is connected with the left slidable table 4. The two left shafts 9, each of which is mounted with one left clamping block 10 at their upper ends respectively, are fixed into the two left bearing blocks 8 via bearings. The two left bearing blocks 8 and the first electric motor 7 are both mounted on the left slidable table 4. The first electric motor 7 drives the two left shafts 9 and the two clamping blocks 10 to rotate via the chain 5. The two right shafts 12, each of which is mounted with one right clamping block 11 at their upper ends, are fixed into the right bearing blocks 13 on the right slidable table 19 via bearings.

The first supporting frame 18 is fixed on the right slidable table 19. The right slidable seat 15, which is mounted with the right lathe tool 14, is connected with the first supporting frame 18 through the second rail 17. The output end of first feeding cylinder 16, which is fixed to the side of the right slidable table 19, is connected with the right slidable seat 15 so as to realize the feeding movement of the right lathe tool 14. The above-mentioned components constitute a right cutting system of the apparatus.

The second supporting frame 27 is fixed on the left slidable table 4. The left slidable seat 29, which is mounted with the left lathe tool 31, is connected with the second supporting frame 27 through the third rail 28. The output end of the second feeding cylinder 30, which is fixed to the side of the left slidable table 4, is connected with the left slidable seat 29 so as to realize the feeding movement of the left lathe tool 31. The above-mentioned components constitute a left cutting system of the apparatus.

The two racks 20, each of which is mounted at lower parts of the left slidable table 4 and the right slidable table 19 respectively, mesh with the gear 21 fixed in the middle of the platform 2. As such, the clamping cylinder 6 could drive the left slidable table 4 to make both the left slidable table 4 and the right slidable table 19 synchronously clamp the wheel blank.

The cylinder 24, the output end of which is fixed with the bracket 26, is mounted to the top end of the supporting plate 23 on the platform 2. The second electric motor 22, which is mounted below the platform 2, drives the conveyor belt 25 to rotate so as to realize on-line processing.

The noses of the left lathe tool 31 and the right lathe tool 14 are both positionally biased from the axis C of the wheel.

During operation, when the wheel blank on the conveyor belt 25 is transported to the central location between the left clamping blocks 10 and the right clamping blocks 11, the blank is stopped by sensor(s) and lifted by the lifting cylinder 24 via the bracket 26. Through the gear 21 and the racks 20, the clamping cylinder 6 drives the left slidable table 4 to make the left slidable table 4 and the right slidable table 19 synchronously clamp the wheel blank. The first electric motor 7 drives the clamped wheel blank to rotate in counterclockwise direction. The first feeding cylinder 16 feeds the right lathe tool 14 to make it contact the wheel rim. The function of removing burrs on the wheel rim, which are caused upon closing molds, is realized by the relative movement between the wheel and the lathe tool. When the wheel blank is produced with misalignment of molds occurring, the right lathe tool 14 will block the wheel and prevent it from rotating, which will make the first electric motor 7 overloaded. Under this circumstance, the right lathe tool 14 could be moved back to its original location. Then the first electric motor 7 dives the clamped wheel blank to rotate in clockwise direction, and the second feeding cylinder 30 feeds the left lathe tool 31. Upon contacting the wheel blank, the left lathe tool 31 could continue the deburring operation.

We claim:

1. An apparatus for on-line deburring wheel blank comprising a body frame (1), a platform (2), a first rail (3), a left slidable table (4), a chain (5), a clamping cylinder (6), a first electric motor (7), two left bearing blocks (8), two left shafts (9), two left clamping blocks (10), two right clamping blocks (11), two right shafts (12), two right bearing blocks (13), a right lathe tool (14), a right slidable seat (15), a first feeding cylinder (16), a second rail (17), a first supporting frame (18), a right slidable table (19), two racks (20), a gear (21), a second electric motor (22), a supporting plate (23), a lifting cylinder (24), a conveyor belt (25), a bracket (26), a second supporting frame (27), a third rail (28), a left slidable seat (29), a second feeding cylinder (30) and a left lathe tool (31), characterized in that:
the left slidable table (4) and the right slidable table (19) are mounted on the platform (2) through the first rail (3);
the output rod of the clamping cylinder (6), which is fixed to the left side of the body frame (1), is connected with the left slidable table (4);
the two left shafts (9), each of which is mounted with one left clamping block (10) at their upper ends respectively, are fixed into the two left bearing blocks (8) via bearings, the two left bearing blocks (8) and the first electric motor (7) are both mounted on the left slidable table (4);
the first electric motor (7) drives the two left shafts (9) and the two clamping blocks (10) to rotate via the chain (5);
the two right shafts (12), each of which is mounted with one right clamping block (11) at their upper ends, are fixed into the right bearing blocks (13) on the right slidable table (19) via bearings;
the first supporting frame (18) is fixed on the right slidable table (19), the right slidable seat (15), which is mounted with the right lathe tool (14), is connected with the first supporting frame (18) through the second rail (17);
the output end of the first feeding cylinder (16), which is fixed to the side of the right slidable table (19), is connected with the right slidable seat (15) so as to realize the feeding movement of the right lathe tool (14), the above-mentioned components constitute a right cutting system of the apparatus;
the second supporting frame (27) is fixed on the left slidable table (4), the left slidable seat (29), which is mounted with the left lathe tool (31), is connected with the second supporting frame (27) through the third rail (28); the output end of the second feeding cylinder (30), which is fixed to the side of the left slidable table (4), is connected with the left slidable seat (29) so as to realize the feeding movement of the left lathe tool (31), the above-mentioned components constitute a left cutting system of the apparatus;
the two racks (20), each of which is mounted at lower parts of the left slidable table (4) and the right slidable table (19) respectively, mesh with the gear (21) fixed in the middle of the platform (2), which allows the left slidable table (4) and the right slidable table (19) to synchronously clamp the wheel blank upon actuation of the clamping cylinder (6);
the lifting cylinder (24), the output end of which is fixed with the bracket (26), is mounted to the top end of the supporting plate (23) on the platform (2); and the second electric motor (22), which is mounted below the platform (2), drives the conveyor belt (25) to rotate.

2. An apparatus for on-line deburring wheel blank according to claim 1, characterized in that when the wheel blank is produced with misalignment of molds occurring so that it is blocked by the right lathe tool (14), the right lathe tool (14) is moved back to its original location and the left lathe tool (31) is fed.

3. An apparatus for on-line deburring wheel blank according to claim 1, characterized in that the noses of the left lathe tool and the right lathe tool are both positionally biased from the axis C of the wheel.
